(19) United States
(12) Patent Application Publication
(10) Pub. No.: US 2013/0060806 A1
(43) Pub. Date: Mar. 7, 2013

(54) Data Solution Composition Architecture

(71) Applicant: Gregory David Swedberg, Bellevue, WA (US)

(72) Inventor: Gregory David Swedberg, Bellevue, WA (US)

(73) Assignee: MICROSOFT CORPORATION, Redmond, WA (US)

(21) Appl. No.: 13/226,871

(22) Filed: Sep. 7, 2011

(51) Int. Cl. G06F 17/30

(52) U.S. Cl. 707/769; 707/E17.014

(57) ABSTRACT

A solution composition architecture for accessing and processing data from multiple simple data sources is provided. The data solution composition architecture allows specification of a query involving any number of data sources for accessing and processing data to produce a solution. Upstream components pass the query (or a portion thereof) to other components. Receiving components process and/or provide the requested data, as applicable, and return the result as in input to the requesting upstream component. The resulting data solution obtained from the query is a single data stream containing a processed data set. Depending upon the availability of and access to the necessary components, the processed data set is generally ready for analysis and/or visualization by the requester.

### BACKGROUND

Data analysis is common in virtually all types of business, research, and education settings regardless of technology. The first step in data analysis is obtaining access to the data to be analyzed. Various data sources are presently available from numerous data providers. These available data sources may be freely accessible or require that the user purchase an access subscription.

Data access is invariably the first step in a long series of steps to generate useful insights. Generally available data sources are either semi-static SQL databases in response to a database specific query language or dynamic third party web services that return a data feed in response to standard web service queries. Unfortunately, data access is presently limited to executing a structured query against a single data source and receiving responsive data in a structured format, typically a tabular format. The data returned must be further processed using tools, such as Microsoft Excel. Moreover, the user often needs to combine the data from multiple data sources to get the desired answer (solution). Finally, the analysis results may be visualized using additional tools that present the data in a meaningful format and allow the user to obtain useful insight from the data.

Windows Azure™ DataMarket is one example of a data provider exposing various data sources to users using a standard interface. A user can construct an arbitrarily complex query on a single database using a data source specific query language or a common interface employed by the data provider. In practice, the complexity of the queries is limited in several ways. First, the data provider may abort queries that take too long to execute. Second, the data provider can limit which columns of their databases are available for use to filter data in a query. Third, data sources backed by third party web services and offered through a data provider may be implemented by mapping the interface of the data provider to the capabilities of the web service. While some web services support virtually the entire interface of the data provider, others only perform very simple queries. Even where the user is not limited by the complexity of the query, the need for the user to execute separate queries on multiple data sources and to manipulate, process, or combine the various individual data sets obtained from each query to arrive at a solution hinders the data analysis process.

It is with respect to these and other considerations that the present invention has been made.

### BRIEF SUMMARY

The following summary is provided to introduce a selection of concepts in a simplified form that are further described below in the Detailed Description. This summary is not intended to identify key features or essential features of the claimed subject matter, nor is it intended to be used to limit the scope of the claimed subject matter.

A solution composition architecture for accessing and processing data from one or more simple data sources (“the data solution composition architecture”) is described herein. The data solution composition architecture allows specification of a query involving any number of data sources for accessing and processing data to produce a solution. Upstream components pass the query (or a portion thereof) to other components. Receiving components process and/or provide the requested data, as applicable, and return the result as an input to the requesting upstream component. The resulting data solution obtained from the query is a single data stream containing a processed data set. Depending on the availability of and access to the necessary components, the processed data set is generally ready for analysis and/or visualization by the requester.

An exemplary use case for one embodiment of the data solution composition architecture joins data from two simple data sources and enriches or validates the data using a third simple data source. In this embodiment, the user uses a client device to execute a remote application hosted by an application server. The solution definition contains a query specifying how one or more data sources are used to collect and process the data providing the solution and any necessary configuration information for those data sources. Generally, the data sources are considered simple data sources or extended data sources. A simple data source, such as a database or web service, provides the original data for the solution. An extended data source transforms or otherwise operates on the original or previously processed data to create the solution.

In operation, the user selects the appropriate solution definition for visualizing the solution. The application server passes the solution definition to the first (i.e., the outermost or most downstream) component in the solution. In order to perform its function, the first component requires input data to operate on. The first component reads the solution definition for the portion of the query that it is to handle. The portion of the solution definition applicable to the first component specifies the output data feed of a second component as the input feed to the first component. There is no need for the first component to understand the remainder of the solution definition. The first component simply passes the solution definition on to the address of the second component and accepts the output data feed of the second component as its input data feed.

The second component, in this scenario, is a data process for transforming two data sets into a single data set. The solution definition for the data transformation specifies two inputs from separate simple data sources. The first input is filtered data from a second simple data source. The second input is filtered data from a third simple data source. The second component pulls the filtered data from the second simple data source and the third simple data source and combines the two data sets into a single combined data set. As with the first component, the second component does not need to understand the parts of the solution definition that are not applicable to it, such as the instructions to the first component. The second component simply returns its output data feed to the downstream requester, the first component in this case.

When the first component receives its input from the upstream component, it processes the data and adds the additional information to the data feed. The data feed from the first component is then returned upstream to the application server. The application server parses the data feed and prepares the visualization of the data. The visualization is then sent to the client device where the user can see the results without the need for further action on the part of the user.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 is a flow diagram of one embodiment of the data solution composition architecture for an exemplary use case that joins data from two simple data sources and enriches or validates the data using a third simple data source;

FIG. 2A illustrates one embodiment of the structure of a solution definition for use in the data solution composition architecture;

FIG. 2B illustrates one embodiment of the structure of an input section for use in the data solution composition architecture;

FIG. 3 illustrates a flow diagram of an alternate data transfer mechanism used in one embodiment of the data source composition architecture; and

FIG. 4 is a block diagram of a system including a computing device with which embodiments of the invention may be practiced.

### DETAILED DESCRIPTION

A solution composition architecture for accessing and processing data from one or more simple data sources (“the data solution composition architecture”) is described herein and illustrated in the accompanying figures. The data solution composition architecture allows specification of a query involving any number of data sources for accessing and processing data to produce a solution. Upstream components pass the query (or a portion thereof) to other components. Receiving components process and/or provide the requested data, as applicable, and return the result as in input to the requesting upstream component. The resulting data solution obtained from the query is a single data stream containing a processed data set. Depending upon the availability of and access to the necessary components, the processed data set is generally ready for analysis and/or visualization by the requester.

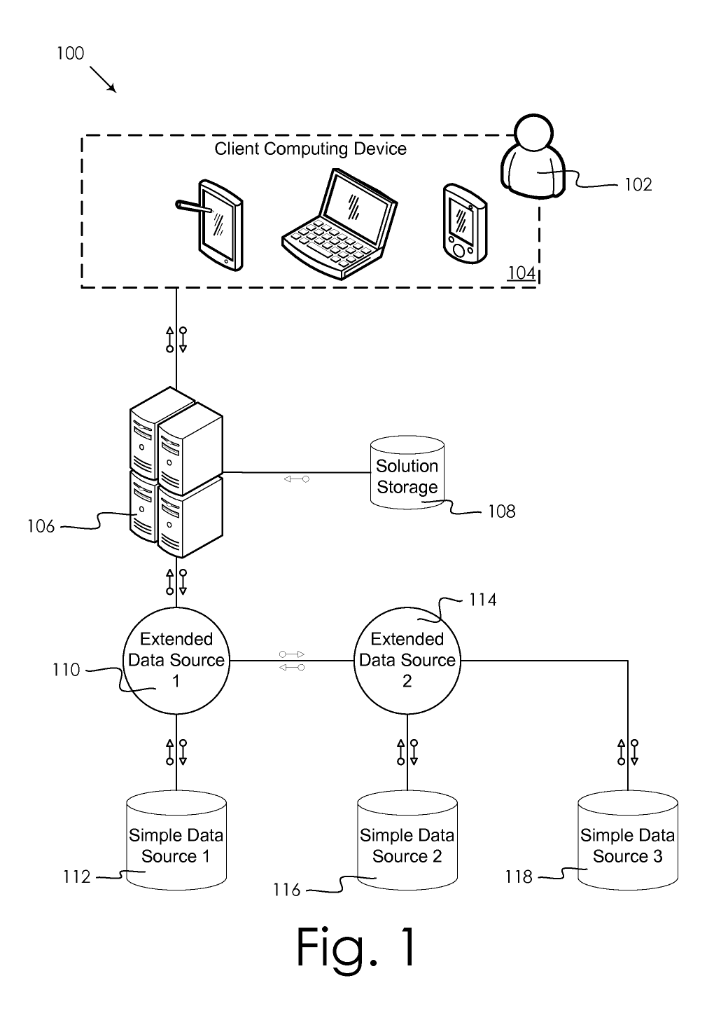

FIG. 1 is a flow diagram of one embodiment of the data solution composition architecture 100 for an exemplary use case that joins data from two simple data sources and enriches or validates the data using a third simple data source. In this embodiment, the user 102 uses a client device 104 to execute a remote application hosted by an application server 106. To give the embodiment context, assume the application server hosts a mapping application and the user desires to see the locations of the parks and the libraries located within a specific geographic region, for example, the user's city. In the simplest scenario, a prepared solution definition meeting the needs of the user exists on a solution storage device 108 and is accessible to the user through the application server 106. The solution definition contains a query specifying how one or more data sources are used to collect and process the data providing the solution, and any necessary configuration information for those data sources. Generally, the data sources are considered simple data sources or extended data sources. A simple data source, such as a database or web service, provides the original data for the solution. An extended data source transforms or otherwise operates on the original or previously processed data to create the solution.

In operation, the user 102 selects the appropriate solution definition for visualizing the city's parks and libraries. The application server 106 passes the solution definition to the first (i.e., the outermost or most downstream) component 110 in the solution. In this example scenario, the first component 110 is a geocoder that enriches the location data by adding the latitude and longitude values associated with a physical address using information from a first simple data source 112 correlating geographic coordinates and physical addresses. Geocoding the data facilitates displaying the locations of the city's parks and libraries on the city map. In order to perform its function, the geocoder requires input data on which to operate. The geocoder reads the solution definition for the portion of the query that it is to handle. The portion of the solution definition applicable to the geocoder specifies the output data feed of a second component 114 as the input feed to the geocoder. There is no need for the geocoder to understand the remainder of the solution definition. The geocoder simply passes the solution definition on to the address of the second component 114 and accepts the output data feed of the second component 114 as its input data feed.

The second component 114, in this scenario, is a data transformation joining two data sets into a single data set (“the joiner”). The solution definition for the data transformation specifies two inputs from separate simple data sources. The first input is from a second simple data source 116. The second simple data source, in this scenario, is a directory containing address information for establishments such as libraries (e.g., a telephone directory database). The data from the second simple data source is filtered by the selected city and the category (e.g., library). In this scenario information about the parks is not available from the second simple data source because the parks do not have associated phone numbers. Instead, information about the city's parks is supplied via a second input using data from a third simple data source 118, which is a database maintained by the city's parks and recreation department. The joiner pulls the filtered data from the telephone directory and the parks and recreation database and combines the two data sets into a single list of places with physical address information. As with the geocoder, the joiner does not need to understand the parts of the solution definition that are not applicable to it, such as the instructions to the geocoder. The joiner simply returns its output data feed to the downstream requester, the first component 110 in this case.

When the geocoder receives its input from the upstream component, it processes the physical addresses and adds the corresponding geographic coordinates to the data feed. The data feed from the geocoder is then returned upstream to the application server. The application server parses the data feed and plots the geographic coordinates for each place on the map. The visualization (i.e., the map data with libraries and parks identified) is then sent to the client device where the user can see the results without the need for further action on the part of the user 102.

Numerous variations of the embodiment of the data solution composition architecture shown in FIG. 1 exist and fall within the scope and spirit of the present invention. In one embodiment, the solution storage device is specific (local) to the application server. In another embodiment, the solution storage device is independent from the application server. In some embodiments, the solution definition is publicly available. In other embodiments, access to the solution definition is limited. In one embodiment, the solution definition is based on a reusable solution definition template that allows selective customization of the data and processes used in the solution by supplying details for selected solution elements at the time of use. In an alternate embodiment, the application server generates a custom solution definition using templates for known simple data sources based on the selected data and processing operations selected by the user. In yet another embodiment, the user generates a solution definition and provides the solution definition to the application server. In either of the alternate embodiments, the custom or user generated solution definition is optionally stored for later use.

In the various embodiments, the remote application is served from an application server over the Internet, a local area network, or a wide area network. Some embodiments employ a specifically addressed application server, while other embodiments utilize a cloud-based application model. The remote application is run directly from the application server in some embodiments. In other embodiments, the application runs in a client-server mode. In one alternate embodiment, the application is a local application that communicates with a data server (replacing the application server) that acts the data solution provider. In another embodiment, the local application communicates directly with the components and acts as the solution definition provider. In one embodiment, the downstream component forwards the entire solution definition to an upstream component. In an alternate embodiment, a downstream component only sends the relevant portion of the solution definition to an upstream component.

Before continuing, it is useful to point out the distinctions between the scenario described above and conventional mapping applications common to global position system devices and online maps. The data available to conventional mapping applications is contained in application specific databases (i.e., silos), and the functionality to manipulate the available data is specific to the application itself. In contrast, the data solution composition architecture provides a reusable solution definition that allows data from a variety of sources, such as relational databases, file systems, content management systems, and traditional web sites to be exposed and accessed, and facilitates processing of the data using a variety of active components.

The solution definition is a composition of one or more components that specifies all of the information necessary to access and process data in order to solve a problem. The various types of components available to the data solution composition architecture include simple data sources, extended data sources, and solutions. Each component has an address or location represented by a uniform resource indicator (URI), e.g., a uniform resource locator (URL), and understands the common data protocol. A simple data source functions as an original source of data by responding to a data solution composition architecture query with an output data feed containing the selected data. Examples of simple data sources include databases and web services. A simple data source does not take any inputs and usually requires no initialization or configuration. A data feed is a collection of entities (data) responsive to a query organized in the common data format. An extended data source is an active component that operates on (e.g., transforms) one or more input data feeds specified by the data solution composition architecture query and produces an output data feed. An extended data source is often an extended component that requires specification of initialization or configuration parameters in addition to the data solution composition architecture query. Examples of an extended data source are queries, macros, scripts, programs, and other similar sets of instructions that perform various tasks such as data enrichment (i.e., supplementing data based on the existing data), data cleansing (validating and standardizing data), and data transformation (modifying and combining data). An alternate embodiment of an extended data source is a data quality process that does not support queries. Instead, the data quality process takes an input data feed containing a list of entities to be corrected and returns an output data feed containing suggested corrections. The component definition for a data quality process differs from the basic extended data source in that it omits the query but includes a description of set of input entities.

From an implementation standpoint, there is little difference between a simple data source delivering original data and an extended data source that operates on inputs from one or more other sources as long as components are defined in a consistent manner. A solution is the final operation on the data feed returned by the other components in the solution definition. The solution usually does not produce an output data feed. One specific type of solution is a visualization. A visualization is a component that visually displays the data returned in response to the solution definition.

As previously mentioned, the solution definition is a query specifying the data sources to use and any necessary configuration information for those data sources to produce a solution (a “data solution composition architecture query”). More specifically, the data solution composition architecture query is made up of an address for a data source together with any optional initialization and/or configuration parameters describing which records to select and how the data should be filtered. Conventional query definitions offer no way, either in the query or in a related metadata document, to specify the configuration information needed to use extended data sources. Supporting composition of extended data sources requires a mechanism to extend the query definition to tell the extended data source where to get the source data and how to initialize the settings of the extended data source. One suitable technique for creating a common data protocol implementing the data solution composition architecture is to allow the configuration information for a component to be contained in the body of the web service request (e.g., a HTTP GET request) and specify initialization and input data parameters in a general way. Initialization information is contained in the body of the feed. Each source element entry in the data feed describes the upstream data source the component should use as a particular named input. Such a technique permits existing data protocols to be extended for use in the data solution composition architecture because placing the configuration information in the body of the web service request allows the common data protocol to contain arbitrary data but not conflict with standard queries in the base protocol. This technique also facilitates passing connectivity information about simple upstream simple data sources to a component. While functional, this technique does not offer a uniform way to discover the connectivity information. Moreover, configuration information and connectivity information cannot easily be passed upstream in complex, multi-stage queries.

In order to handle complex, multi-stage queries, the common data protocol employs a machine readable structured encoding language that allows the nesting of elements to encode the configuration and connectivity information in the body of the data solution composition architecture query for each upstream component. Each upstream component that directly provides an input to the current component is specified by nesting the configuration and connectivity information for that upstream component as an input within the configuration and connectivity information of the current component. In one embodiment, the structured encoding language is both machine readable and human readable. One suitable structured encoding language is the Extensible Markup Language (XML); however, other suitable structured encoding languages will be recognizable to those skilled in the art.

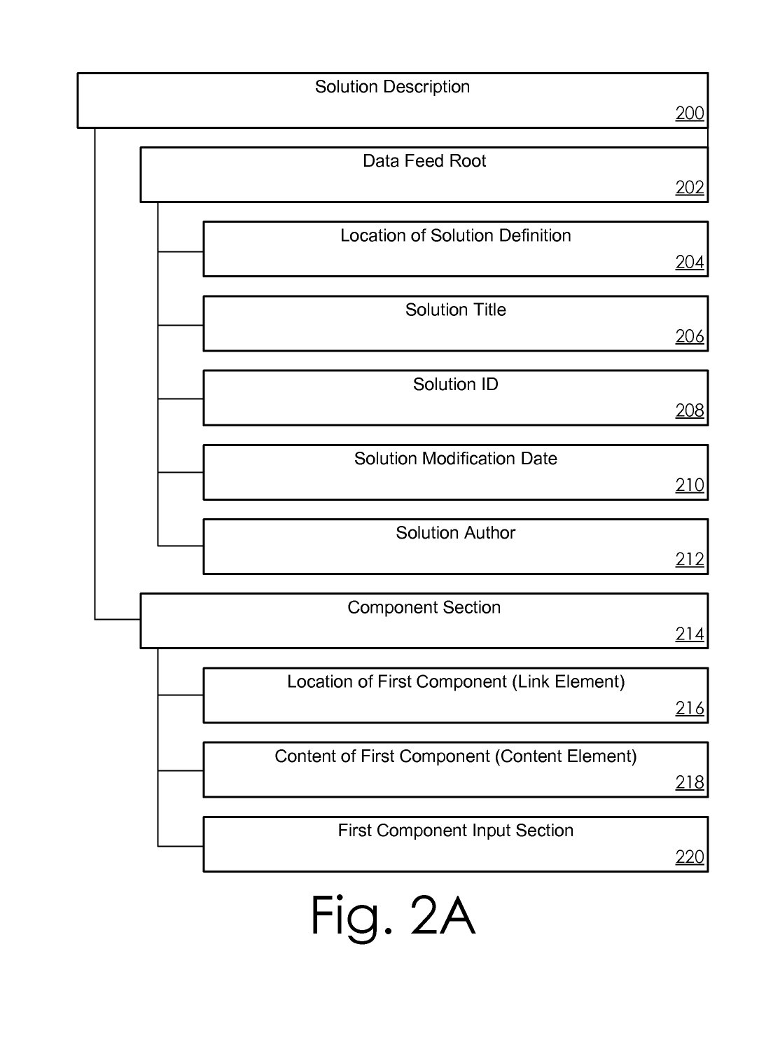

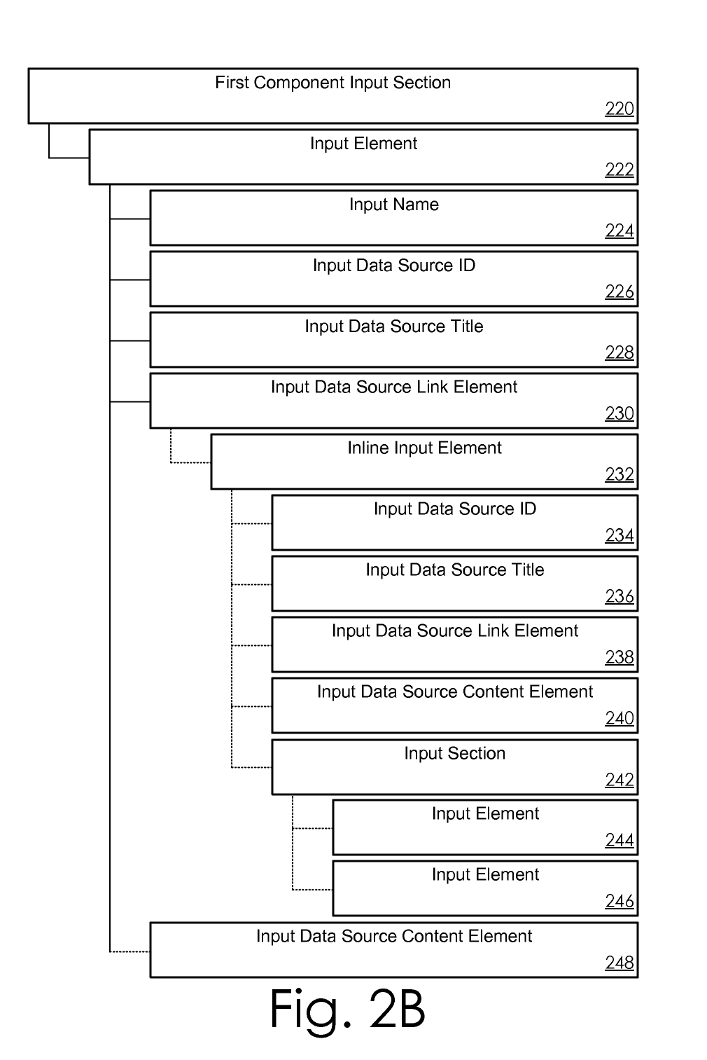

FIG. 2A illustrates one embodiment of the structure of a solution definition for use in the data solution composition architecture. The solution definition is described in a data feed 200 that is passed to the data sources. The root 202 of the data feed describes the overall solution including a self-referral link to the location of the solution definition 204 and optional related elements such as a title 206, a solution identifier 208, the modification date 210, and the solution author 212. Next, the solution definition 200 contains a component section 214 for the first component of the solution that includes a link element 216, a content element 218, and one or more input elements 220. The link element 216 describes the location of the first component in the solution. The content element 218 specifies the configuration properties for the first component in the solution.

FIG. 2B illustrates one embodiment of the structure of an input section for use in the data solution composition architecture. The data solution composition architecture 100 allows the components to be specified in a very flexible way. If upstream data source is a simple data source, the input element 222 contains the name attribute 224, an identifier element 226, a title element 228, and a link element 230. The name attribute is used to map an upstream data source to the appropriate input of the current component. The link element is used to invoke the upstream component. If the upstream data source is an extended data source, the link element 230 specifies an inline data feed 232 describing the upstream extended data source and/or a content element 248 containing initialization parameters for the extended data source. In one embodiment, the inline data feed 232 includes an identifier element 234, a title element 236, a link element 238, a content element 240. In the illustrated embodiment, the inline data feed 232 includes an input section 242 having two input elements 244, 246 that describe downstream data sources providing input data feeds to the component. The data solution composition architecture 100 supports solutions chaining together an arbitrary number of components of arbitrary type chained together. Additional input sections and input elements are added as needed. When multiple components are needed to produce a solution, the solution definition allows additional input elements to be nested in the data solution composition architecture query as deep as necessary to specify a complete solution. For example, if a solution requires component A to operate on an input data feed from component B, the configuration description describing the setup for component B is in-lined into the content element and/or the link element for the appropriate input of component A.

The data source composition architecture allows for variations in defining the input requirements. In one embodiment, the inputs are specified as a fixed requirement that must be matched by the input data feed. In an alternate embodiment, the configuration information for the data source specifies the inputs as required fields. In this instance, the input data feed must provide records with fields of the same type in the same order as the required fields but could optionally include additional information. In yet another alternate embodiment, the configuration information for the data source includes mapping information specifying the mapping between the fields in the input data feed and the fields required by the data source.

A common data protocol shared and understood between the components allows the solution to use data from a variety of simple data sources that would typically be accessed using simple data source specific queries. The common data protocol includes a common data format and a common query format understood by each of the components used in the solution. The common data protocol allows the components to take direction from the solution definition, process input data feeds, and properly format output data feeds. One suitable common data protocol is the Open Data Protocol (OData); however, other web protocols could be developed or extended and used to implement to the common data protocol without departing from the scope and spirit of the present invention.

In the exemplary embodiment of the data solution composition architecture, data flow is described as a synchronous pull model. The solution is executed by sending a query to the final component with the entire solution definition as the body of the web service request to each upstream component providing data to the final component. In turn, each component pulls input data from the upstream components(s) mapped to the input(s) of that component. This process continues until the simple data sources are reached.

The synchronous pull model means that all queries are independent and each component is limited to a single output. Because the queries are synchronous and do not require state information to be maintained, the components are idempotent. In other words, the result remains the same each time the solution is executed unless the underlying datasets change). While a pull based data flow offers simplicity, an alternate embodiment of the data solution composition architecture employs an asynchronous pull and push model where the individual components store state information for later access.

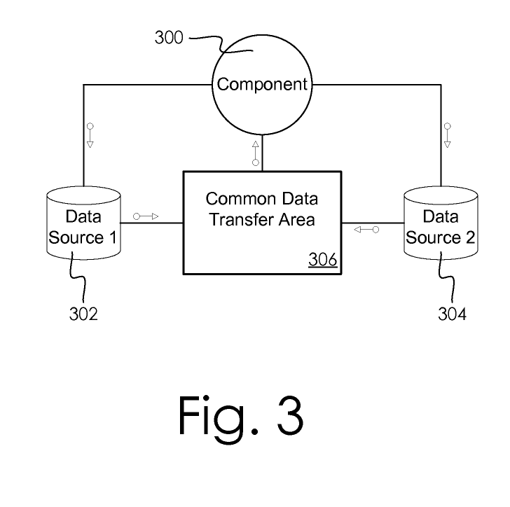

FIG. 3 illustrates a flow diagram of an alternate data transfer mechanism used in one embodiment of the data source composition architecture. In the embodiment of FIG. 1, the data responsive to the query is returned in a data feed using the HTTP protocol. For large data feeds, the HTTP protocol limits the speed of the data transfer. In FIG. 3, a component 300 takes a first input from a first data source 302 and a second input from a second data source 304. The component 300 and the two data sources 302, 304 all have access to and can communication with a common transfer location 306 (e.g., a memory unit) at transfer speeds greater than that available using the HTTP protocol. Rather than return the data feed using the HTTP protocol, the each data source writes the data to the common transfer location 306, and the component reads the data from the common transfer location 306. The result is substantially increased data transfer speeds.

A solution definition is most beneficial when it is reusable and accessible to multiple users. The location where solution definitions are stored affects the mechanisms for and the complexity of sharing the solution definitions and how the user interacts with the solution definition. Generally, the scenarios for sharing a solution definition are characterized as private sharing (e.g., one-to-one private sharing or one-to-many private sharing) or public sharing (e.g., unrestricted/non-commercial/free public sharing and restricted/commercial public sharing). Private sharing requires an easy to use solution and is generally familiar to users. Public sharing is requires strict control and implicates a more complicated process because of an increased lack of familiarity with private sharing mechanisms.

The simplest solution for private storage is for the user to store a solution definition as a text file on their local machine, a network machine, or the SkyDrive associated with the user's Live account. With private storage at the user level, a user shares the solution definition like any other file and retains control over who has access to the solution definition. Storing the solution definition as a local file brings with it all of the capabilities and paradigms of the file system: reading, writing, editing, copying, access control, and sharing. The user owns the solution definition and has direct access allowing the user to manipulate the solution definition as they would any other file.

Alternatively, a solution definition stored in the cloud is referred to by reference and the rights the user has to access and/or manipulate the solution definition subject to be arbitrarily limitations. The ability to limit user access requires implementation of custom mechanisms to handle all of the standard operations available with local file systems.

Storing solution definitions on solution storage using the same authentication credentials as the data service provider enjoys the benefit of ready access to available solution definitions with minimum authentication issues. For example, using SkyDrive as solution storage for solution definitions used with the DataMarket web site is relatively simple because the user signs into Live ID to authenticate with both services.

Public storage refers to stored solutions distributed through a data provider or similar entity (“the publisher”). Typically, the data provider will need the ability to review a solution definition before it is made publicly available. Ultimately, the solution definition is uploaded to a solution storage location controlled by the publisher and accessed only by reference. In the case of commercial solution definitions, the publisher implements strict access controls and/or billing systems to protect the economic benefit derived from the commercial solution definition.

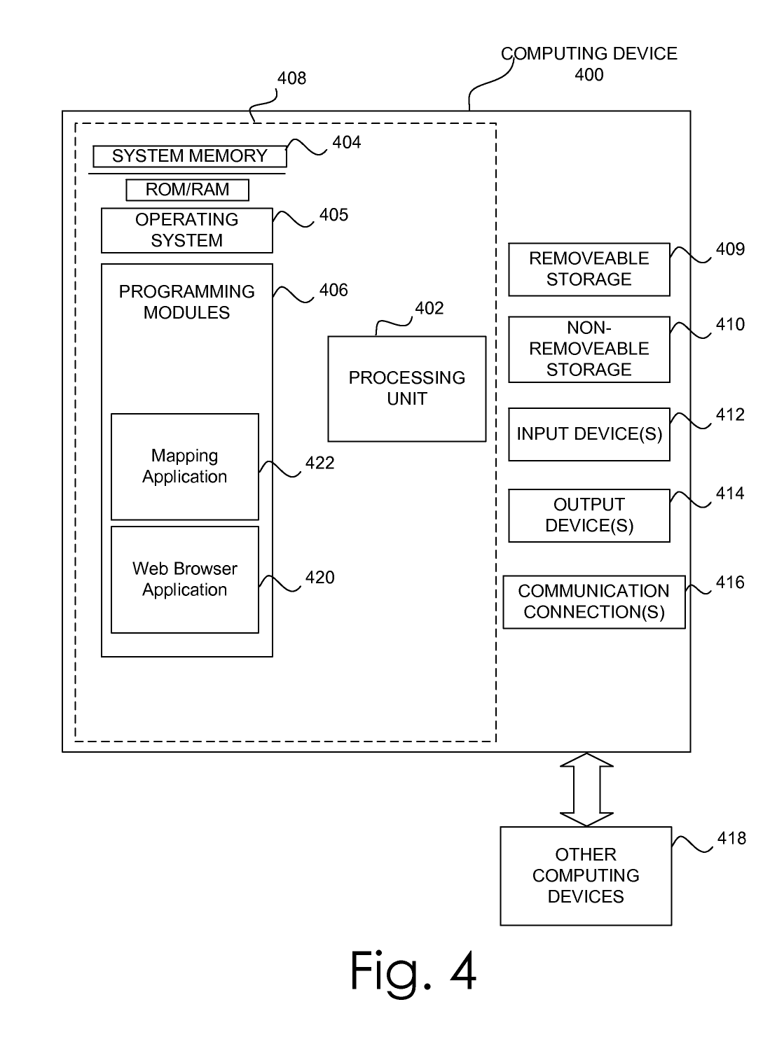

The embodiments and functionalities described herein may operate via a multitude of computing systems such as the client device 104 and application server 106, described above with reference to FIG. 1, including wired and wireless computing systems, mobile computing systems (e.g., mobile telephones, tablet or slate type computers, laptop computers, etc.). In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIG. 4 and the associated descriptions provide a discussion of an example operating environment in which embodiments of the invention may be practiced. However, the device and systems illustrated and discussed with respect to FIG. 4 are for purposes of example and illustration and are not limiting of a vast number of computing device configurations that may be utilized for practicing embodiments of the invention, described herein.

FIG. 4 is a block diagram illustrating example physical components of a computing device 400 with which embodiments of the invention may be practiced. The computing device components described below may be suitable for any of the computing devices described above, for example, the client computing devices 104 and the server device 106. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a web browser application 420. Operating system 405, for example, may be suitable for controlling the operation of computing device 400. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410.

As stated above, a number of program modules and data files may be stored in system memory 404, including operating system 405. While executing on processing unit 402, programming modules 406, such example the mapping application 422 described above, may perform processes described above. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 400 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

What is claimed is:

1. A method of querying a composition of data sources to produce a solution, said method comprising the steps of:
providing a common data protocol having a common data format and a common query format;
providing a solution definition specifying a query in said common query format having a first portion to retrieve a first collection of data from a first data source and a second portion to retrieve a second collection of data from a second data source as an input to said first data source;
passing said solution definition to said first data source;
executing said first portion of said query on said first data source;
passing said solution definition from said first data source to said second data source;
executing said second portion of said query on said second data source;
returning said second collection of data from said second data source to said input of said first data source in said common data format;
completing execution of said first portion of said query using said second collection of data to produce said first collection of data; and
returning said first collection of data from said first data source in said common data format as a solution to said query.

2. The method of claim 1 further comprising the step of specifying a location of said first data source in said first portion of said query and a location of said second data source in said second portion of said query.

3. The method of claim 1 further comprising the step of specifying configuration parameters for said second data source in said second portion of said query.

4. The method of claim 1 further comprising the steps of:
specifying a location of said first data source in said first portion of said query;
specifying configuration parameters for said first data source in said first portion of said query; and
specifying a location of said second data source in said second portion of said query.

5. The method of claim 1 wherein said step of executing said query on said first data source further comprises the step of issuing a web service request against a uniform resource identifier.

6. The method of claim 1 wherein said step of providing a solution definition further comprises the steps of:
formatting said solution definition in a structured markup language;
specifying a location of said first data source as a web service request against a uniform resource identifier in a first location element in said solution definition;
specifying an input for said first data source in an input element in said solution definition; and
specifying a location of said second data source as a web service request against a uniform resource identifier in a second location element nested within said input element in said solution definition.

7. The method of claim 6 wherein said step of providing a solution definition further comprises the steps of:
specifying configuration parameters for said first data source in a first content element in said solution definition; and
specifying configuration parameters for said second data source in a second content element nested within said input element in said solution definition.

8. The method of claim 1 wherein said step of providing a solution definition further comprises the steps of specifying a property for a selected data field from said second data source.

9. The method of claim 1 wherein said common data protocol is the Open Data Protocol.

10. The method of claim 1 wherein said step of returning said second collection of data further comprises the step of:
writing said second collection of data from said second data source to a common transfer location; and
reading said second collection of data to said first data source from said common transfer location.

11. The method of claim 1 further comprising the step of inserting a variable in said solution definition to allow a user to customize said solution definition by specifying a value for said variable when the user uses said solution definition to obtain a solution.

12. A method of querying a composition of data sources to produce an answer to a question, said method comprising the steps of:
providing a set of instructions for getting information from a first data source and using said information in a second data source to produce an answer to said question;
sending said question definition to said second data source;
sending said question definition from said second data source to said first data source according to said instructions;
getting information from said first data source according to said instructions;
getting said information from said first data source at said second data source according to said instructions; and
using said information in said second data source to produce an answer.

13. The method of claim 12 wherein said step of providing a set of instructions further comprises the steps of:
specifying an input for said second data source; and
specifying an instruction to said second data source to get said information from said first data source through said input.

14. The method of claim 13 wherein said step of specifying an instruction to said second data source to get said information further comprises the step of specifying an instruction to said second data source to use a first address to access said first data source.

15. The method of claim 14 further comprising the step of specifying an instruction to said first data source describing said information that said first data source should provide.

16. The method of claim 15 further comprising the step of placing said instruction to said first data source describing said information that said first data source should get inside said instruction to said second data source to use a first address to access said first data source.

17. The method of claim 12 wherein said step of providing a set of instructions further comprises the step of specifying an instruction on how to set up said second data source.

18. The method of claim 12 further comprising the step of saving said set of instructions for reuse.

19. A computer readable medium containing computer executable instructions which when executed by a computer perform a method of querying a composition of data sources to produce a solution, said method comprising the steps of:
providing a common data protocol having a common data format and a common query format;
specifying a location of said first data source as a web service request against a uniform resource identifier in a first location element of a query in a solution definition;
specifying an input for said first data source in an input element of said query in said solution definition;
specifying a location of said second data source as a web service request against a uniform resource identifier in a second location element nested within said input element of said query in said solution definition;
passing said solution definition to said first data source;
executing said first portion of said query on said first data source;
passing said solution definition from said first data source to said second data source;
executing said second portion of said query on said second data source;
returning said second collection of data from said second data source to said input of said first data source in said common data format;
completing execution of said first portion of said query using said second collection of data to produce said first collection of data; and
returning said first collection of data from said first data source in said common data format as a solution to said query.

20. The computer readable medium of claim 19 further comprising the steps of:
specifying configuration parameters for said first data source in a first content element in said solution definition; and
specifying configuration parameters for said second data source in a second content element nested within said input element in said solution definition.
